(19) United States
(12) Patent Application Publication
(10) Pub. No.: US 2012/0017731 A1
(43) Pub. Date: Jan. 26, 2012

(54) SLICER FOR FOOD ITEMS

(76) Inventors: Michael R. Mastroianni, Crystal Lake, IL (US); Aurelio Reyes, Sugar Grove, IL (US)

(21) Appl. No.: 12/842,672

(22) Filed: Jul. 23, 2010

(51) Int. Cl. B26D 1/00; A47J 43/04

(52) U.S. Cl. 83/13; 99/537

(57) ABSTRACT

A slicer for quickly slicing food items includes a cavity into which a food item can be inserted, a plurality of blades for slicing the food item, and a pressing portion for pressing the food item onto the plurality of blades.

### BACKGROUND

The present invention relates to cooking utensils, and more particularly to utensils for slicing food items.

Slicing food items such as stalk-type items like carrots, celery, scallions, mushrooms, asparagus, and rhubarb into thin slices (e.g., substantially disk-shaped for circular cross-section items) using a knife is a delicate and difficult task. Furthermore, trying to perform such slicing while keeping the slices to a similar thickness further complicates the process.

### SUMMARY

In one embodiment, the invention provides a slicer for slicing food items. The slicer has a body including a cutting portion having a plurality of cutting blades coupled thereto and defining a cavity adjacent the plurality of cutting blades for receiving a food item to be sliced. The body further includes a handle portion. The slicer also has a drive arm pivotally connected to the body, the drive arm including a pressing portion operable to press the food item received in the cavity against the plurality of cutting blades to slice the food item. The drive arm further includes a handle portion.

In another embodiment, the invention provides a slicer for slicing food items. The slicer has a body including a cutting portion having a plurality of cutting blades coupled thereto and defining a cavity adjacent the plurality of cutting blades for receiving a food item to be sliced, a wall portion that acts as a stop for the food item being inserted into the cavity, and a handle portion. The slicer also has a drive arm pivotally connected to the body, the drive arm including a pressing portion having a plurality of ribs and being operable to press the food item received in the cavity against the plurality of cutting blades to slice the food item, and a handle portion. In addition, the slicer has a biasing member operable to bias the handle portion of the drive arm away from the handle portion of the body.

In another embodiment the invention provides a method of slicing food items with a slicer, the slicer having a body including a handle portion, a cutting portion, and a plurality of cutting blades coupled to the cutting portion, the body defining a cavity adjacent to the plurality of cutting blades. The slicer further includes a drive arm having a handle portion and a pressing portion, the drive arm being pivotally connected to the body. The method includes inserting a food item into the cavity, squeezing the handle portion of the body and the handle portion of the drive arm together, thereby moving the pressing portion toward the cutting blades and slicing the food item, and releasing the handle portion of the body and the handle portion of the drive arm thereby allowing movement of the pressing portion away from the cutting blades. Next, the method includes inserting the food item further into the cavity, squeezing the handle portion of the body and the handle portion of the drive arm together, thereby moving the pressing portion towards the cutting blades and slicing the food item, and releasing the handle portion of the body and the handle portion of the drive arm thereby allowing movement of the pressing portion away from the cutting blades.

Other aspects of the invention will become apparent by consideration of the detailed description and accompanying drawings.

### BRIEF DESCRIPTION OF THE DRAWINGS

FIG. 1 is a perspective view of a slicer embodying the invention shown in an open position.

FIG. 2 is a perspective view of the slicer of FIG. 1 shown in the closed position.

FIG. 3 is a partial bottom view of the body of the slicer of FIG. 1.

FIG. 4 is a partial bottom view of the drive arm of the slicer of FIG. 1.

FIG. 5 is a cross sectional view of the slicer of FIG. 1 taken through line 5-5 of FIG. 1.

FIG. 6 is an enlarged partial perspective view of the slicer of FIG. 1, showing the drive arm and the body locked together.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

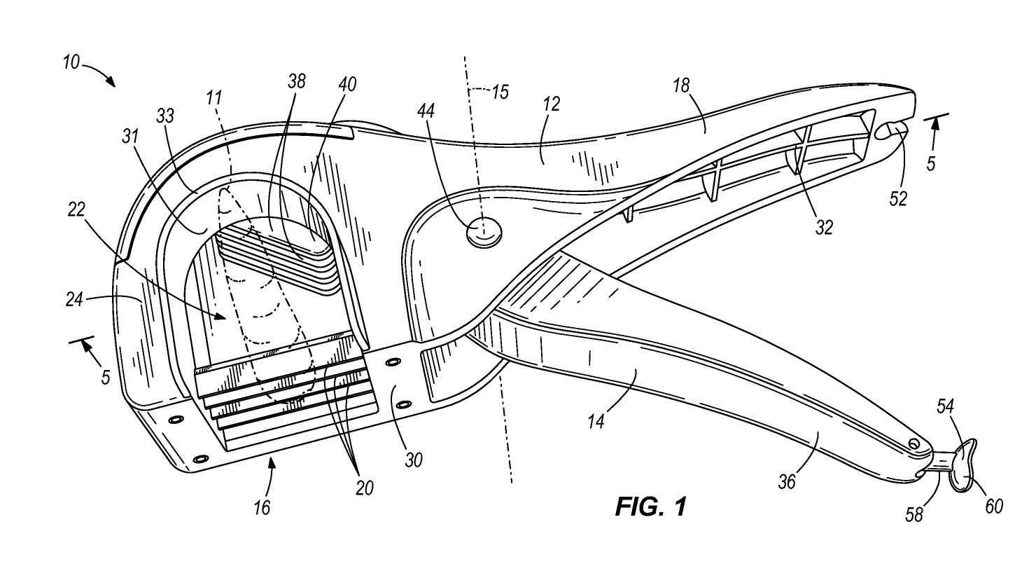

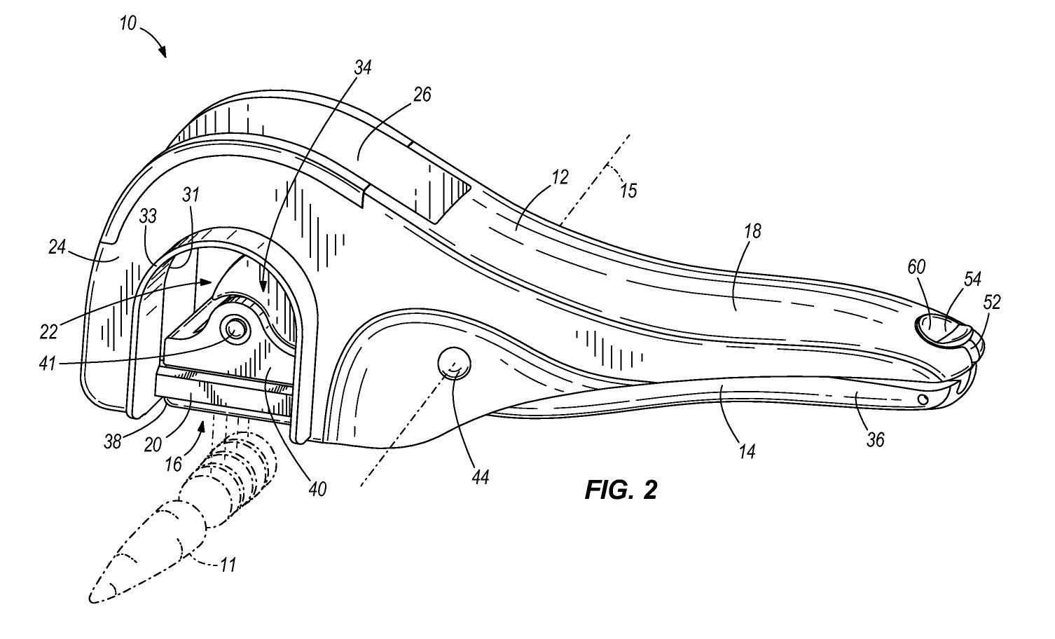

FIGS. 1 and 2 illustrate a slicer 10 of the present invention. The slicer 10 serves to cut a stalk-type, elongated food item 11 (e.g. carrot, celery, rhubarb) into a plurality of slices. The slicer 10 may also be used to cut other food items such as bread, sausage, etc. The slicer 10 includes a body 12 and a drive arm 14 pivotally coupled to the body 12 about a pivot axis 15 (see FIGS. 1, 2, and 5) for movement between an open position (see FIG. 1) and a closed position (see FIG. 2).

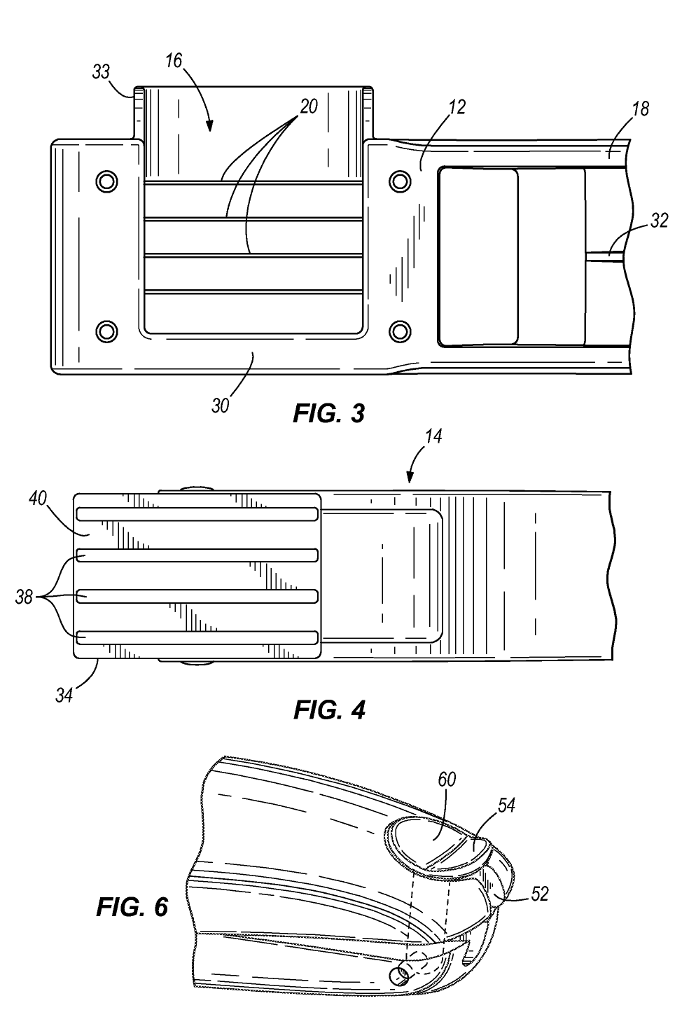

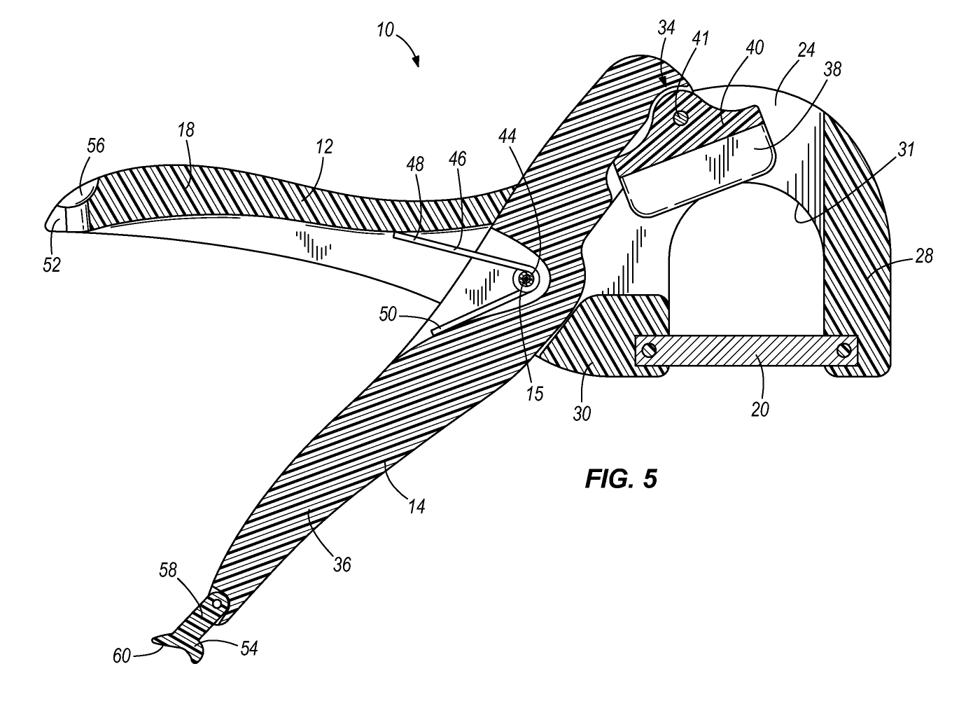

With reference to FIGS. 1-3, the body 12 includes a cutting portion 16 and a handle portion 18. The cutting portion 16 includes a plurality of blades 20, a first wall portion 24, a second wall portion 26, a front wall portion 28 (see FIG. 5), and a bottom wall portion 30, that together define a cavity 22. In the illustrated embodiment the first wall portion 24 is planar and has a curved section which defines an opening 31 to the cavity 22 so that the elongated food item 11 can be at least partially inserted into the cavity 22 from the side of the body 12. In other words, the food item 11 can be inserted into the cavity 22 in a direction substantially parallel to the pivot axis 15, as is shown in FIG. 1, as opposed to being inserted into the cavity in a direction generally transverse to the pivot axis. This feature makes the slicer 10 well-suited for use with elongated food items that will not fit entirely into the cavity 22. In the illustrated embodiment, an optional rim or lip 33 extends laterally from the first wall portion 24 and about the opening 31 to provide added guidance for insertion of the food item 11 into the opening 31. The lip 33 also helps to strengthen and reinforce the cutting portion 16.

The first wall portion 24, and therefore the opening 31, lies in a plane transverse to the pivot axis 15, and in the illustrated embodiment, lies in a plane that is normal to the pivot axis 15. The first wall portion 24 is coupled to the front wall portion 28 and the bottom wall portion 30. The second wall portion 26 is planar and has a curved section mirroring the curvature of the first wall portion 24. In the illustrated embodiment, the first and second wall portions 24, 26 define generally parallel side walls of the cutting portion 16. The second wall portion 26 is coupled to the front wall portion 28 and the bottom wall portion 30. The front wall portion 28 is curved and coupled to and extends between the first and second wall portions 24, 26. The front wall portion 28 is also coupled to the bottom wall portion 30. The bottom wall portion 30 includes a recess in the bottom wall portion 30 across which the plurality of blades 20 extend. In another embodiment, the second wall portion 26 has an opening therein such that a food item may pass through the cavity 22 without contacting the slicer 10.

The plurality of blades 20 are coupled to the bottom wall portion 30 and the front wall portion 28. In the illustrated embodiment, the four cutting blades 20 are molded into the bottom wall portion 30 and the front wall portion 28. A side of each blade 20 is sharpened for cutting. Each blade 20 is coupled to the body 12 such that the sharpened portion is facing the cavity 22 (up in FIGS. 1 and 2). In the illustrated embodiment four blades 20 are used. Other embodiments contemplate using more or fewer blades 20. In the illustrated embodiment the blades 20 are evenly spaced apart (e.g., about 0.5 centimeters apart), although other embodiments contemplate having the blades 20 spaced unevenly. As shown in FIG. 1, the cavity 22 receives the food item 11 to be sliced laterally through the opening 31, with the food item 11 extending substantially parallel to the pivot axis 15 and generally transverse to the elongated direction of the blades 20. The second wall portion 26 acts as a stop for the food item 11; that is, the food item 11 can be inserted into the cavity 22 from the side until the food item 11 contacts the second wall portion 26 and cannot be inserted further into the cavity 22.

The handle portion 18 of the body 12 is coupled to the cutting portion 16 of the body 12, and in the illustrated embodiment, the handle portion 18 is integrally formed with the cutting portion 16. The handle portion 18 is curvilinear and is shaped such that a person is able to comfortably grip the handle portion 18 using his hand. The under-side of the handle portion 18 has a grid pattern of stiffening ribs 32 disposed thereon to substantially prevent the handle portion 18 from bending or flexing, while at the same time minimizing the amount of material required to manufacture the handle portion 18. The handle portion 18 includes first and second apertures (not shown) disposed on the handle portion 18 near the cutting portion 16 for receiving a pin 44 that pivotally couples the body 12 to the drive arm 14.

With reference to FIGS. 1, 2 and 4, the drive arm 14 includes a pressing portion 34 and a handle portion 36. In the illustrated embodiment, the pressing portion 34 is sized and configured to fit between an area bounded by the first and second wall portions 24, 26 to define an upper boundary or ceiling of the cavity 22. The pressing portion 34 includes a plurality of pressing ribs 38. In the illustrated embodiment, the pressing ribs 38 are sized and configured such that at least one pressing rib 38 of the plurality of pressing ribs 38 is able to fit all the way into a space between an adjacent two of the plurality of blades 20 to enable complete pressing of the food item 11 through the plurality of blades 20 (see FIG. 2). In the illustrated embodiment, the number of pressing ribs 38 equals the number of blades 20, however this need not be the case. As best seen in FIG. 5, the illustrated pressing portion 34 includes a pressing member 40 that is pivotally connected to the drive arm 14 by a pin 41. The pressing member 40 is pivotally connected to the drive arm 14 to allow the pressing ribs 38 to apply a substantially even pressure to a food item 11 and to substantially prevent the food item 11 from slipping against the plurality of blades 20 when the food item 11 comes into contact with and is driven through the plurality of blades 20. In another embodiment, the pressing member 40 and the drive arm 14 need not be pivotally connected, but can be non-pivotally fixed together.

The handle portion 36 of the drive arm 14 is shaped such that a user is able to comfortably use his fingers to press on the handle portion 36 of the drive arm 14 to squeeze the handle portion 36 of the drive arm 14 and the handle portion 18 of the body 12 together. In the illustrated embodiment, the handle portion 36 of the drive arm 14 is sized so that it may be partially disposed or received within the handle portion 18 of the body 12 when the slicer 10 is in the closed position. The handle portion 36 is smooth on one side so that the user is able to comfortably use his fingers to press on the handle portion 36, but the other side of the handle portion 36 has a grid pattern of stiffening ribs (not shown), similar to the stiffening ribs 32, disposed thereon to substantially prevent the handle portion 36 from bending or flexing while at the same time minimizing the amount of material required to manufacture the handle portion 36. The handle portion 36 includes first and second apertures (not shown) near the pressing portion 34 to align with the apertures on the body 12 and receive the pin 44 that pivotally couples the body 12 to the drive arm 14.

FIG. 5 is a cross sectional view of the slicer 10. In the illustrated embodiment, the drive arm 14 is pivotally connected to the body 12 by the pin 44 at a location intermediate to the opposite ends of the slicer 10 to provide a scissors-type action. Bushings (not shown) are placed on the pin 44, between the drive arm 14 and the body 12 in order to reduce friction between the drive arm 14 and the body 12. In addition, bushings allow for the drive arm 14 and the body 12 to be manufactured with large tolerances, allowing the drive arm 14 and body 12 to be manufactured at a lower cost. A biasing member in the form of a torsion spring 46 is disposed on the pin 44. The torsion spring 46 has a first arm 48 and a second arm 50, the first arm 48 pressing against the handle portion 18 of the body 12 and the second arm 50 pressing against the handle portion 36 of the drive arm 14. The torsion spring 46 thus provides a biasing force to separate the handle portion 18 of the body 12 and the handle portion 36 of the drive arm 14 to bias the slicer 10 towards the open position (see FIG. 1). The force of the torsion spring 46 is generally sufficient to overcome any friction that may result when a piece of food is caught between a pressing rib 38 and a blade 20, but the force of the torsion spring 46 is small enough that a user with minimal hand gripping strength is able to overcome the force of the torsion spring 46 to move the slicer 10 to the closed position (see FIG. 2). In other embodiments the biasing member need not be a torsion spring and need not be disposed on the pin 44. The biasing member could take other forms of biasing members disposed between the body 12 and the drive arm 14 (e.g., a compression spring).

With reference to FIGS. 1-2, 5 and 6, a slot 52 is disposed on the handle portion 18 to receive a locking member 54. A generally bowl shaped recess 56 (see FIG. 5) is formed about the slot 52 for receiving the locking member 54. The locking member 54 is pivotally connected to the drive arm 14. In the illustrated embodiment, a stem portion 58 of the locking member 54 is sized and configured to fit within the slot 52. The locking member 54 has a generally bowl shaped portion 60 coupled to an end of the stem portion 58 and is sized and configured to mimic the contours of the recess 56 such that the bowl shaped portion 60 of the locking member 54 is able to substantially fit into the generally bowl shaped recess 56. Other embodiments contemplate placing the locking member 54 on the body 12 and the slot 52 and recess 56 on the drive arm 14.

In order to place the slicer 10 in the locked position, the locking member 54 is positioned so that it will not interfere with placing the slicer 10 in the closed position. The user then presses the handle portion 36 of the drive arm 14 close to the handle portion 18 of the body 12. Next, the user rotates the locking member 54 into the slot 52 and recess 56, thus coupling the body 12 and drive arm 14 together and placing the slicer 10 in the locked position (see FIG. 2). When the slicer 10 is in the locked position, the handle portion 18 of the body 12 and the handle portion 36 of the drive arm 14 are held close together such that food may not be inserted into the cavity 22. In order to release the slicer 10 from the locked position to the unlocked position, the user presses the handle portion 36 of the drive arm 14 against the handle portion 18 of the body 12. Next, the user rotates the locking member 54 away from the recess 56 and slot 52, thus placing the slicer 10 in the unlocked position.

In order to slice food items 11 with the slicer 10, the user grasps the slicer 10 in his hand. The user then inserts a food item 11 in a direction substantially parallel to the pivot axis 15 into the cavity 22 through the opening 31 in the first wall portion 24 with his other hand until an end of the food item 11 is stopped by the second wall portion 26 (see FIG. 1). Next, the user squeezes the handle portion 18 of the body 12 and the handle portion 36 of the drive arm 14 together, thereby moving the pressing portion 34 towards the cutting blades 20 and slicing the food item 11. The pressing member 40 pivots as needed relative to the drive arm 14 based on the contour of the food item 11 to apply an even and consistent pressing force. The portions of the food item 11 that are sliced may fall away from the slicer 10 (see FIG. 2) into a container or onto a countertop, depending on the orientation of the slicer 10 in relation to the container or countertop. The user then releases the handle portion 18 of the body 12 and the handle portion 36 of the drive arm 14, thereby allowing the pressing portion 34 to move away from the cutting blades 20 due to the bias of the spring 46. As used herein and in the appended claims “releasing the handle portion 18 of the body 12 and the handle portion 36 of the drive arm 14,” means the user remains in control of the slicer 10 such that the user's hand is still in contact with the handle portion 36 of the drive arm 14 and the handle portion 18 of the body 12, but that the squeezing force is released or relaxed to allow the slicer 10 to return to its open position.

Next, the user inserts the partially sliced food item 11 further into the cavity 22 in a direction substantially parallel to the pivot axis 15 until it again abuts the second wall portion 26. After that, the user again squeezes the handle portion 18 of the body 12 and the handle portion 36 of the drive arm 14 together, thereby moving the pressing portion 34 towards the cutting blades 20 and slicing the food item 11. The portions of the food item 11 that are sliced may fall away from the slicer 10 into a container or onto a countertop, depending on the orientation of the slicer 10 in relation to the container or countertop. The user then releases the handle portion 18 of the body 12 and the handle portion 36 of the drive arm 14, thereby allowing the pressing portion 34 to move away from the cutting blades 20 due to the bias of the spring 46. This process can be repeated until the entire food item 11 is sliced.

The illustrated embodiment provides a method and device for quickly slicing a food item 11 into slices. The slicer 10 is able to cut a food item 11 into substantially uniform slices, a task that is difficult to accomplish using a knife. In addition, the slicer 10 is generally safer to use than a knife because the sharpened edges of the plurality of blades 20 face toward the cavity 22, thus reducing the likelihood of an accidental cut to the user. The ability to insert the food item 11 into the cavity 22 from the side (i.e., in a direction substantially parallel to the pivot axis 15) allows the slicer 10 to be used for slicing elongated food items, such as stalk-type food items 11.

Thus, the invention provides, among other things, a slicer 10 capable of slicing various food items. Various features and advantages of the invention are set forth in the following claims.

What is claimed is:

1. A slicer for slicing food items, the slicer comprising:
a body including
a cutting portion having a plurality of cutting blades coupled thereto and defining a cavity adjacent the plurality of cutting blades for receiving a food item to be sliced, and
a handle portion; and
a drive arm pivotally connected to the body about a pivot axis, the drive arm including
a pressing portion operable to press the food item received in the cavity against the plurality of cutting blades to slice the food item, and
a handle portion;
wherein the cutting portion includes a wall portion defining an opening to the cavity that is configured for receiving the food item into the cavity in a direction substantially parallel to the pivot axis.

2. The slicer of claim 1, wherein the wall portion is a first wall portion and wherein the cavity is further defined by a second wall portion that acts as a stop for the food item being inserted into the cavity.

3. The slicer of claim 1, wherein the first wall portion and the second wall portion are generally parallel side walls of the cutting portion.

4. The slicer of claim 1, wherein the plurality of cutting blades includes four cutting blades spaced evenly apart.

5. The slicer of claim 4, wherein the four cutting blades are each spaced approximately 0.5 centimeters apart.

6. The slicer of claim 1, wherein the pressing portion includes a pressing member pivotally connected to the drive arm.

7. The slicer of claim 6, wherein the pressing member includes a plurality of pressing ribs.

8. The slicer of claim 7, wherein there are an equal number of pressing ribs and cutting blades.

9. The slicer of claim 7, wherein the pressing ribs are positioned so that at least one rib can be pressed into a space between an adjacent two of the cutting blades.

10. The slicer of claim 1, wherein the pressing portion includes a plurality of pressing ribs.

11. The slicer of claim 10, wherein there are an equal number of pressing ribs and cutting blades.

12. The slicer of claim 10, wherein the pressing ribs are positioned so that at least one rib can be pressed into a space between an adjacent two of the cutting blades.

13. The slicer of claim 1, wherein the drive arm is pivotally connected to the body using a pin.

14. The slicer of claim 1, further comprising a biasing member coupled between the body and the drive arm to bias the pressing portion away from the plurality of cutting blades.

15. The slicer of claim 1, further comprising a lock member disposed on one of the handle portion of the drive arm and the handle portion of the body.

16. The slicer of claim 15, further comprising an opening on the other one of the handle portion of the drive arm and the handle portion of the body to receive the lock member.

17. The slicer of claim 1, further comprising a lip extending from the wall portion and about the opening.

18. A slicer for slicing food items, the slicer comprising:
a body including
a cutting portion having a plurality of cutting blades coupled thereto and defining a cavity adjacent the plurality of cutting blades for receiving a food item to be sliced, and
a handle portion;
a drive arm pivotally connected to the body about a pivot axis positioned intermediate to opposite ends of the slicer, the drive arm including
a pressing portion having a plurality of ribs and being operable to press the food item received in the cavity against the plurality of cutting blades to slice the food item, and
a handle portion; and
a biasing member operable to bias the handle portion of the drive arm away from the handle portion of the body;
wherein the cavity of the cutting portion is defined by a first wall portion defining an opening to the cavity that is configured for receiving the food item into the cavity in a direction substantially parallel to the pivot axis, and a second wall portion opposite the first wall portion that acts as a stop for the food item being inserted into the cavity through the opening in the first wall portion.

19. A method of slicing food items with a slicer including
a body having a handle portion, a cutting portion, and a plurality of cutting blades coupled to the cutting portion, the body defining a cavity adjacent to the plurality of cutting blades; and
a drive arm having a handle portion and a pressing portion, the drive arm being pivotally connected to the body about a pivot axis; the method comprising:
inserting a food item into the cavity in a direction substantially parallel to the pivot axis;
squeezing the handle portion of the body and the handle portion of the drive arm together, thereby moving the pressing portion towards the cutting blades and slicing the food item;
releasing the handle portion of the body and the handle portion of the drive arm thereby allowing movement of the pressing portion away from the cutting blades;
inserting the food item further into the cavity in a direction substantially parallel to the pivot axis;
squeezing the handle portion of the body and the handle portion of the drive arm together, thereby moving the pressing portion towards the cutting blades and slicing the food item; and
releasing the handle portion of the body and the handle portion of the drive arm thereby allowing movement of the pressing portion away from the cutting blades.

20. The method of claim 19, wherein the slicer includes a plurality of pressing ribs disposed on the pressing portion, and wherein squeezing the handle portion of the body and the handle portion of the drive arm together moves at least one of the pressing ribs into a space between an adjacent two of the cutting blades.

21. The method of claim 19, wherein the pressing portion is pivotally attached to the drive arm and wherein squeezing the handle portion of the body and the handle portion of the drive arm together causes the pressing portion to pivot relative to the drive arm.
